(19) United States
(12) Patent Application Publication
(10) Pub. No.: US 2002/0162582 A1
(43) Pub. Date: Nov. 7, 2002

(54) Optical fiber connector system cleaning machine

(76) Inventors: Ching Chu, Kent, WA (US); Zhong-Ming Mao, Kent, WA (US); Shangyuan Huang, Kent, WA (US)

Correspondence Address: Brobeck Phleger & Harrison LLP, 12390 El Camino Real, San Diego, CA, 92130-2081, US

(21) Appl. No.: 09/736,591

(22) Filed: Dec. 13, 2000

(51) Int. Cl. B08B 3/12

(52) U.S. Cl. 134/105; 134/186

(57) ABSTRACT

Various embodiments of an apparatus and methods capable of cleaning the end surface of an optical fiber connector, particularly a jet of cleaning liquids with vacuum removal system, clean fluid pressure and/or vacuum, plasma discharge, steam jet, and ultrasound field.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to general cleaning of the end surface of an optical fiber connector, particularly the methods and apparatus for using a jet of cleaning liquids with vacuum removal system, clean fluid pressure and/or vacuum, plasma discharge, steam jet, and ultrasonic cavitation effect.

In the area of optical fiber use, a fiber is terminated with a ferrule portion of a connector system, the connector system is fitted into an adapter, and the adapter is mounted in a panel of the equipment wherein it is to be used. In this case, a sleeve surrounds an outer diameter of the ferrule which extends longitudinally beyond an exposed end of the ferrule, forming a female tip, A complementary ferrule lacks a surrounding sleeve and is referred to as a male tip. The ferrule-sleeve system as described above is utilized in multiple systems of optical fiber connection. These systems include the screw-on fiber connector, called FC/PC for physical contact and FC/APC for angled physical contact, the SC connector (PC and APC), the Lucent LC connector, the MU connector, the 3M connector, the MT-RJ connector, and the locking type connector, called ST. Because it is a prevalent connector system, the FC/PC, or physical contact fiber connector system will be portrayed in drawings for this application. However, anyone expert in the field would recognize that any of the types above, as well as another type not yet standard in the industry, permits the following cleaning methods claimed herein.

During use of said equipment, contaminants including dust, finger oils, and grease collect within the connector system, or jumper, and settle on the optical fiber end surface on each ferrule. Contaminants may be carried by the ambient air or introduced to the physical contact interface via the hands of the human operator. Said contaminants prevent the physical contact interface which is necessary to optimize signal strength across the connector system interface. Prevention of contact occurs in the following three ways. Firstly, particulate matter between the two ferrules of the connector system causes distance from physical contact so that optical signal is lost. Secondly, particulate matter between either ferrule and the sleeve offsets the ferrule from the connector system axis, causing misalignment of the optical fiber. Thirdly, grease or other contaminant on the surface of the optical fiber causes attenuation of optical signal, owing to the fact that most contaminants are highly light absorptive.

To clean the connector system requires a user to open the equipment box, unplug the connector system from the adapter which houses it, remove the sleeve to gain access to the ferrule and fiber surfaces, clean the surfaces, usually with a solvent such as acetone, reassemble the connector system, replug the connector system into the adapter, and reinstall the adapter into the equipment box. During the foregoing process, it is desirable that the connector system not be recontaminated during the necessary handling involved.

To clean the connector system without disassembling the equipment box, it has been common in the industry to use a cotton swab for in-place cleaning of the optical surface. This has the drawback that cotton fibers may remain on the surface so cleaned, and impurities collect on the periphery of the optical surface.

U.S. Pat. No. 4,637,089 to Schwarz teaches an apparatus for cleaning an optical surface by means of a rod-shaped member with a cleaning wick at each of its two ends, said apparatus providing for the simultaneous cleaning of a male and female tip at each of its ends, respectively. The above-noted rod-shaped apparatus has the drawback that fibers from the wick may remain on the surface so cleaned.

Compressed air is also employed for in-place cleaning. This method has the disadvantage that it fails to effectively remove oils from the optical surface. An added disadvantage is dust from the optical surface or from the end of the ferrule could be displaced by the air stream to the interface between the sleeve and the ferrule's side, forcing a gap to appear at the interface and causing signal loss through misalignment.

U.S. Pat. No. 6,053,985 to Cheswick, et al. teaches an apparatus for cleaning optical surfaces by means of a high-bonding adhesive surface. This apparatus requires disassembly of the optical connector system from the adapter to access the optical connector system for cleaning. A currently available variation of this apparatus, using adhesive tape in a cartridge, has the same disadvantage.

U.S. Pat. No. 4,733,428 to Malinge, et al. teaches an apparatus for cleaning an optical surface, particularly well adapted to cleaning surfaces where access is difficult. A tool provides for a cleaning fluid, and then a drying gas, to be sent under pressure onto the optical surface by an injector and evacuated by means of a jacket surrounding the injector. The cleaning fluid described could be a gas such as air.

The above-noted apparatus has the drawback of requiring two jacket types to permit cleaning of both male and female tips. An additional drawback is that the apparatus relies only on fluid pressure and chemical action of the cleaning fluid to clean an optical surface.

### BRIEF SUMMARY OF THE INVENTION

Accordingly, it is an object of the present invention to provide a means to clean an optical surface, ferrule, and sleeve, without disassembly of the equipment in which it is enclosed, by access to ferrule connector tip only.

It is another object of the present invention to provide a means to clean an optical surface with non-contact methods only, to avoid problems inherent in contact methods such as remnant fibers, relocated but still extant contaminants, and potential damage to the optical surface.

Still another object of the present invention is to minimize the use of toxic chemicals in the work place, therefore several embodiments of the invention are described which use nontoxic cleaning methods.

Another object of the present invention is to eliminate the need for the added expense of multiple jacket types which accommodate the connector tip when it is both in and out of an adapter structure.

The apparatus of all of the embodiments of the present invention may be inserted into a sleeve of a female optical fiber tip, said sleeve to be used for alignment of the cleaning apparatus. The apparatus of the present invention may also be used to clean a male optical fiber tip to which a sleeve has been added. To demonstrate the cleaning of each of the aforementioned types of tips, a sleeve common to the field is depicted in FIGS. 1-5, which sleeve is shaped in the form of a cylinder divided along its longitudinal axis to provide a means for delivering a radial compression force on the outside of an enclosed ferrule. However, no specific sleeve type is necessary to the cleaning method and this sleeve can be replaced by any component better suited to the task

The foregoing objects and advantages of the invention are illustrative of those which can be achieved by the present invention and are not intended to be exhaustive or limiting of the possible advantages which can be realized. Thus, these and other objects and advantages of the invention will be apparent from the description herein or can be learned from practicing the invention, both as embodied herein and as modified in view of any variations that may be apparent to those skilled in the art. Accordingly, the present invention resides in the novel methods, arrangements, combinations and improvements herein shown and described.

### BRIEF DESCRIPTION OF THE SEVERAL VIEWS OF THE DRAWING

FIG. 1 is a sectional view of an ultrasonic liquid jet/vacuum cleaning method and apparatus.

FIG. 2 is a sectional view of a sleeve-ferrule interface cleaning method and apparatus.

FIG. 3 is a sectional view of a fiber connector plasma cleaning method and apparatus.

FIG. 4 is a sectional view of an H.sub.2.O steam jet/vacuum cleaning method and apparatus.

FIG. 5 is a sectional view of an ultrasound field interactive cleaning method and apparatus.

### DETAILED DESCRIPTION OF THE INVENTION

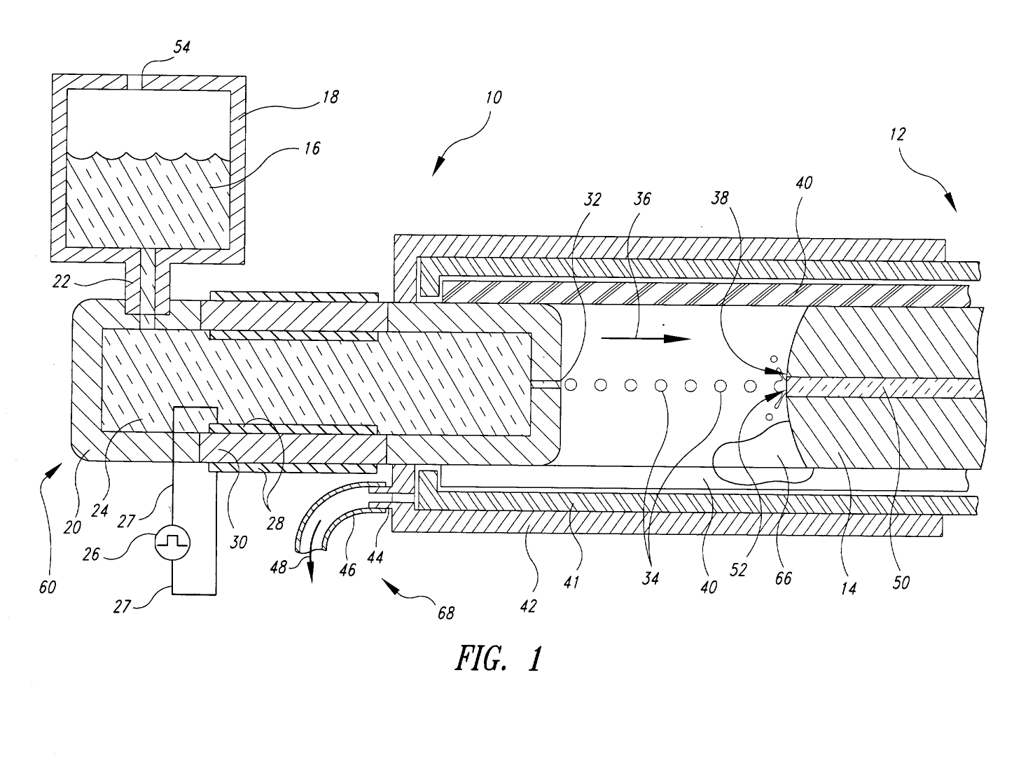

It should be noted that like parts depicted in FIGS. 1 to 5 are represented by like reference numbers so that descriptions of these parts are not repeated for the sake of simplicity.

In the first, preferred, embodiment, depicted in FIG. 1, a liquid jet apparatus 10 includes a liquid jet probe body 60, an attachable vacuum shroud 42, and an attachable liquid reservoir 18. The liquid jet probe body 60 includes a tank assembly 20, a piezo material 30 in contact with at least two electrical contacts 28, and at least two electrical wires 27 connecting the electrical contacts 28 to a drive electrical signal 26. Said tank assembly 20 includes a compression tank 24 and a liquid nozzle 32. The liquid reservoir 18 includes a cleaning liquid 16 contained by the reservoir, a delivery tube 22, and a reservoir vent hole 54. The vacuum shroud 42 includes a vacuum port 44 and an attachable vacuum tube 46. The cleaning liquid 16 may comprise any volatile liquid which is compatible with the cleaning of an optical fiber connector system, including but not limited to acetone, alcohol, a mixture of water and acetone, or a mixture of water and alcohol.

In FIG. 1, an optical fiber connector tip 12 is depicted of a type common in the industry, said tip comprising a ferrule 14 enshrouding an optical fiber 50 with an optical fiber end surface 52. A sleeve 40 holds the ferrule 14 by friction. A housing 41 loosely encloses the sleeve 40. The aforementioned arrangement is that of a female connector tip common in the industry. A male connector tip is cleanable by the present invention if the male connector tip is first enclosed with the sleeve 40, in which case the housing 41 is not present.

The tank assembly 20 is inserted in an insertion direction 36 so as to be partly enclosed by the sleeve 40 of the optical fiber connector tip 12 such that the vacuum shroud 42 covers and abuts on the exposed edge of the housing 41, which housing 41 itself covers and encloses the sleeve 40. The sleeve 40 serves to guide the liquid nozzle 32 toward axial alignment with the ferrule 14.

The cleaning liquid 16 in the liquid reservoir 18 passes through the delivery tube 22 into the compression tank 24. The drive electrical signal 26 is transmitted through the electrical wires 27 to the electrical contacts 28 which are in contact with the piezo material 30. The piezo material 30 is deformable in such a way as to impart a vibration wave upon the cleaning liquid 16 inside the compression tank 24, which vibration wave is directed longitudinally along the axis of the compression tank 24. Thus, the cleaning liquid 16 is propellable by the force of the imparted vibration wave through the liquid nozzle 32 in the form of droplets 34. Said droplets 34 cross the distance between the liquid nozzle 32 and the ferrule 14 at high speed, impacting an impact surface 38. The effect of the impact is to dissolve oily contaminants and dislodge dust particles from the impact surface 38, from the inside of sleeve 40, and particularly from the optical fiber end surface 52, forming a slurry 66. The slurry 66 is removable by means of the vacuum port 44 and thence through the vacuum tube 46 in removal direction 48. Removal would preferably occur before the cleaning liquid 16 is allowed to escape the sleeve 40 and housing 41 of the optical fiber connector tip 12, inasmuch as escaped liquid could damage components within the environment which surrounds the optical fiber connector tip 12.

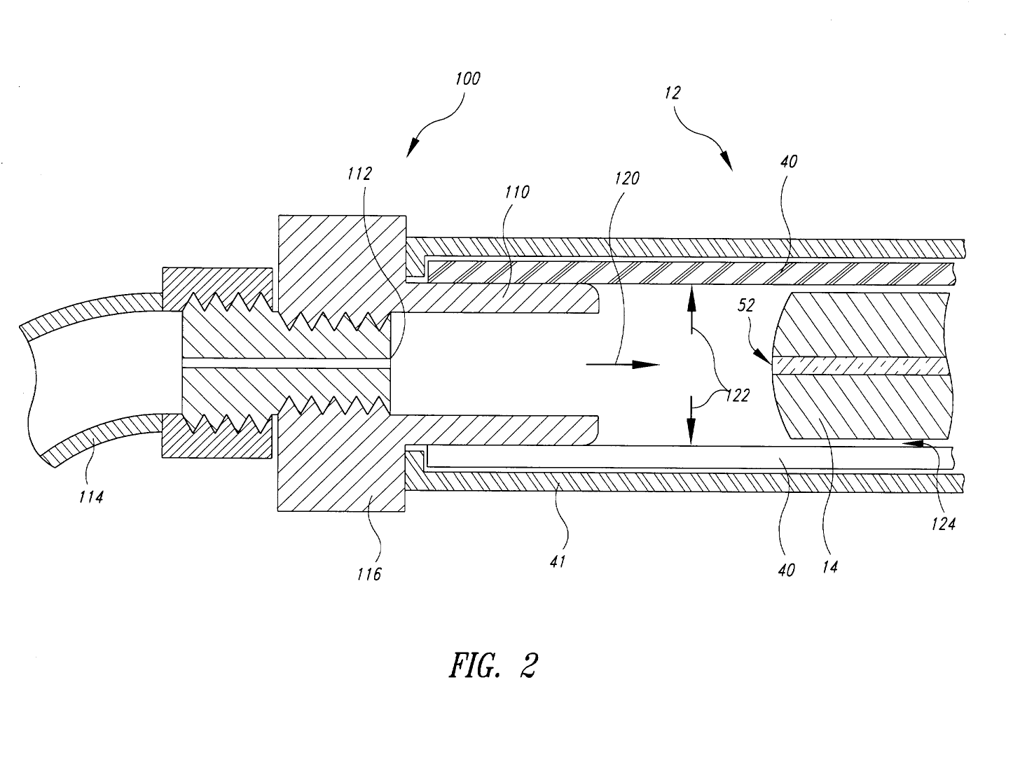

In the second embodiment, depicted in FIG. 2, a sleeve-ferrule interface cleaning apparatus 100 includes an oversize cleaning ferrule 110, a pressure nozzle 112, and a pressure hose 114 attached to a gas pressure source which is not shown.

The oversize cleaning ferrule 110 is inserted in the orientation shown in insertion direction 120 into the sleeve 40 of the optical fiber connector tip 12 and facing the exposed tip of the ferrule 14, so that the sleeve 40 expands in sleeve opening direction 122, that is, outward in all directions from the longitudinal axis of the optical fiber connector tip 12. The effect of the expansion of the sleeve 40 is to form a sleeve-ferrule interface gap 124 between the sleeve 40 and the ferrule 14. In this embodiment, the oversize cleaning ferrule 110 is positioned relative to the ferrule 14 by a shoulder 116. The shoulder 116 abuts the housing 41 in a female connector tip, and it abuts the sleeve 40 which is added for the cleaning of a male connector tip.

Negative or positive gas pressure may be provided by means of the pressure nozzle 112. Using positive gas pressure, a powerful gas flow is expressed through the pressure hose 114 and from the pressure nozzle 112. Particulate matter is dislodged from the surface of ferrule 14, and hence from the optical fiber end surface 52. Said particulate matter is suspended in the gas and transported around the ferrule 14 through the sleeve-ferrule interface gap 124, thence out of the optical fiber connector tip entirely, at which point the particulate matter will cease to be a factor in signal loss. If negative gas pressure is used, ambient air is drawn through the sleeve-ferrule interface gap 124, past the ferrule 14, toward the optical fiber end surface 52, and thence into the pressure nozzle 112, dislodging and carrying any particulates suspended in the air.

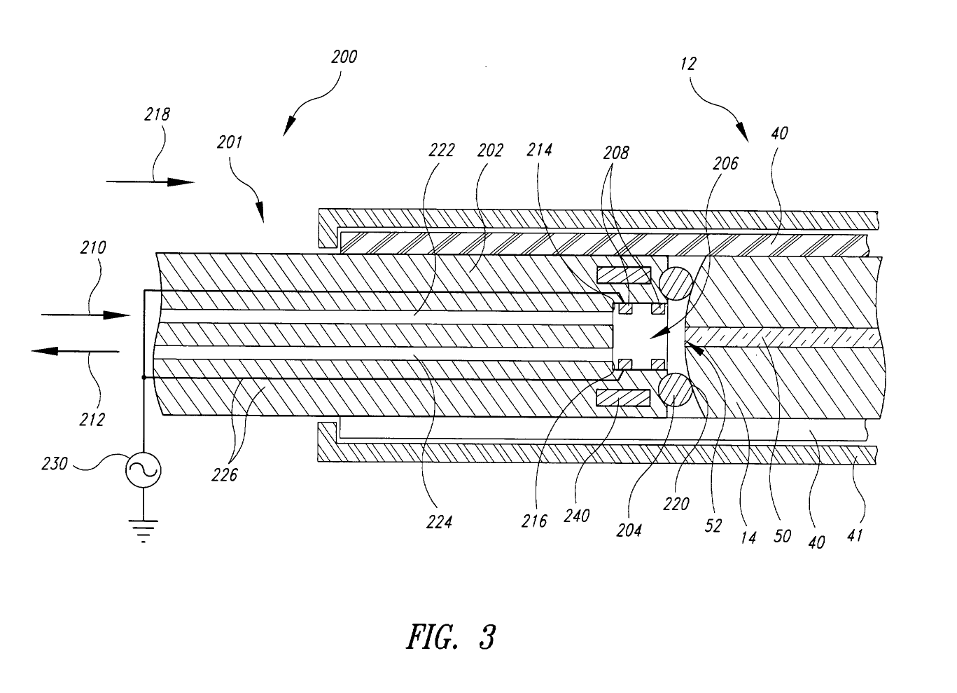

In the third embodiment, depicted in FIG. 3, a plasma cleaning apparatus 200 comprises a sleeve interface assembly 201 and a gas pressure source and sink, both of which are not shown, and may be any of a variety of configurations available in the marketplace. The sleeve interface assembly 201 comprises a sleeve interface body 202, a plasma diffraction and focus system 240, an O-ring seal 204, and a pressure containment chamber 206. The pressure containment chamber 206 comprises a plurality of electrodes 208, a gas injection nozzle 214 which terminates gas injection passage 222, and a gas removal nozzle 21 6 which terminates a gas removal passage 224.

The plasma cleaning apparatus 200 is inserted into the exposed end of sleeve 40 of the optical fiber connector tip 12 in an apparatus insertion direction 218, which insertion is stopped by the contact of the O-ring seal 204 with the exposed end of the ferrule 14 at the seal ferrule interface 220, said O-ring seal enclosing the space defined as the pressure containment center 206. The pressure containment chamber 206 is centrally located at the proximal end of the sleeve interface body 202, and said pressure containment chamber 206 is aligned with and immediately adjacent to the optical fiber end surface 52. The outer diameter of the sleeve interface body 202 closely approximates the outer diameter of the ferrule 14 which is being cleaned, and therefore the close fit of the sleeve interface body 202 within the sleeve 40 ensures alignment of the pressure containment chamber 206 with the optical fiber end surface 52.

A gas is introducible by means of the gas injection passage 222 in the gas injection direction 210. Said gas may be air or a particular composition such as gas with a high concentration of oxygen. Said gas enters the pressure containment chamber 206, sealable from the environment by the O-ring seal 204. A plasma is then generated by any of several methods (for instance: gas ionization from high voltage DC or AC source; RF power generator). In this embodiment, toroidal electrodes 208 are depicted which, when energized through electrical leads 226 by power source 230, serve to dissociate the gas into positively and negatively charged ions. The plasma thus created within the pressure containment chamber 206 acts to oxidize and to reduce the contaminants residing on the exposed optical fiber end surface 52, and it would also serve to neutralize the charge on any dust particles which adhere, due to static attraction, to the surface of the ferrule 14.

It may or may not be necessary to direct and focus plasma toward the optical fiber end surface 52 using electrostatic or magnetic means, for optimal cleaning effect.

In the embodiment depicted in FIG. 2, a plasma diffraction and focus system 240, in the form of a toroidal permanent magnet, is included in the plasma cleaning apparatus 200 to provide the aforementioned means.

Oxygen molecules, or O.sub.2, used as an etchant gas with RF generated plasma will remove organic contamination but will not etch off glass from the optical fiber end surface 52, from the ferrule 14, nor from other optical connector system parts commonly available in the industry. O.sub.2 will remove some of the epoxy which is standardly used in the industry from the gap between the optical fiber 50 outer diameter and the ferrule 14 inner diameter, however the etching depth is only approximately 10,000 Å.

Plasma, because of its composition of dissociated positively and negatively charged particles (in addition to neutral particles), will react with a wide variety of substances. The plasma generation process can be readily controlled and contained, and therefore effectively eliminates the safety hazards and liquid waste associated with wet cleaning processes known to one of average knowledge in the field.

In a variation on the plasma cleaning apparatus embodiment depicted in FIG. 2, a combination of oxidation gas and ions is creatable at a location external to the interface between the apparatus 200 and the ferrule 14, said combination then being introduced through the gas injection passage 222 and gas injection nozzle 214.

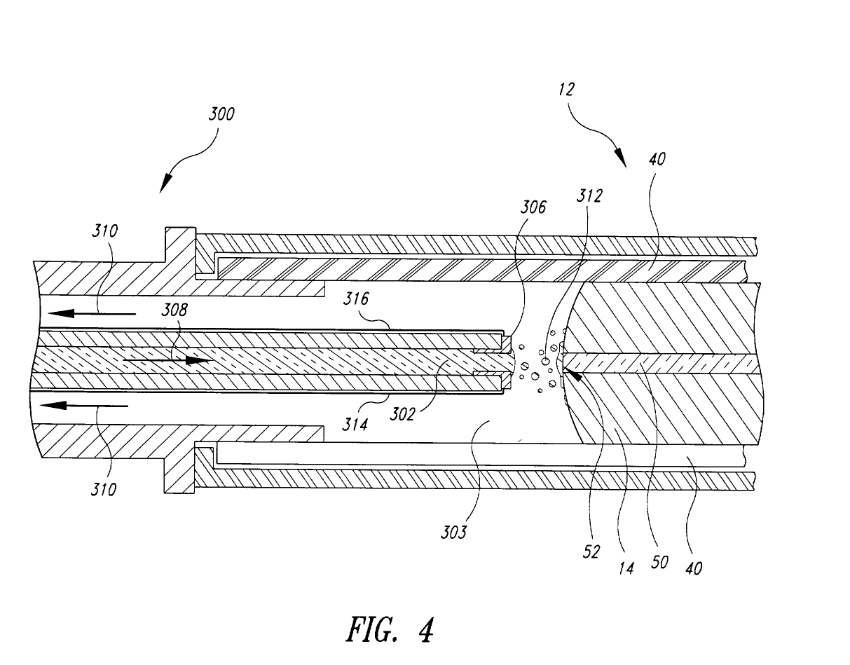

In a fourth embodiment, depicted in FIG. 4, a steam cleaning apparatus 300 comprises a liquid transfer tube 304, a heater element 306, lead wires 314 and 316, and a steam cleaning liquid 302.

As shown in FIG. 4, a quantity of the steam cleaning liquid 302 is introduced through the liquid transfer tube 304 to the proximity of the optical fiber end surface 52 in the liquid injection direction 308. At this time, the heater element 306 may be activated to generate heat of a magnitude capable of vaporizing the steam cleaning liquid 302 to form a vapor spray 303. In the case of an electrical resistance heater, lead wires 314 and 316 provide electrical power for the heating process. The heated liquid 312 acts to dissolve and suspend contaminants previously attached to the optical fiber end surface 52 and the ferrule 14. The heated liquid 312 may or may not be induced to change phase, in its entirety, from liquid to vapor. Vapor generated from the heated liquid 312 will act to further clean the optical fiber end surface 52 and the ferrule 14. After a suitable duration, during which time the optimal amount of contaminants has been displaced, liquid, vapor, and dissolved and suspended contaminants are removable in the fluid removal direction 310 by means of a vacuum source which is not shown. A steadily supplyable quantity of steam cleaning liquid 302 may be directed through the liquid transfer tube 304 to replenish the liquid bead 303 until the desired amount of cleaning has occurred, at which time the remainder of the steam cleaning liquid 302 may be removed.

Steam cleaning liquid 302 means employed in this embodiment may be pure water (H.sub.2.O) or may comprise water and a solvent such as alcohol, acetone, or other suitable chemical. By capturing the steam cleaning liquid 302 after its use, the solvents and contaminants may be filtered out, so as to prevent their escape into the environment.

The supply of steam cleaning liquid 302, or steam cleaning liquid supply, which is not shown, must be capable of providing a controlled amount of the steam cleaning liquid 302 to the proximal tip of the liquid transfer tube. Controlled flow is required so that excess steam cleaning liquid 302 does not enter the environment of the optical fiber connector tip 12.

Vacuum suction means employed in this embodiment must also be controlled so as to optimize the cleaning process, so that the steam cleaning liquid 302 is not removed before ample heating has been provided by the heater element 306.

Energy source means employable in this embodiment for heating purposes include current of DC or AC type, RF, microwave, and light.

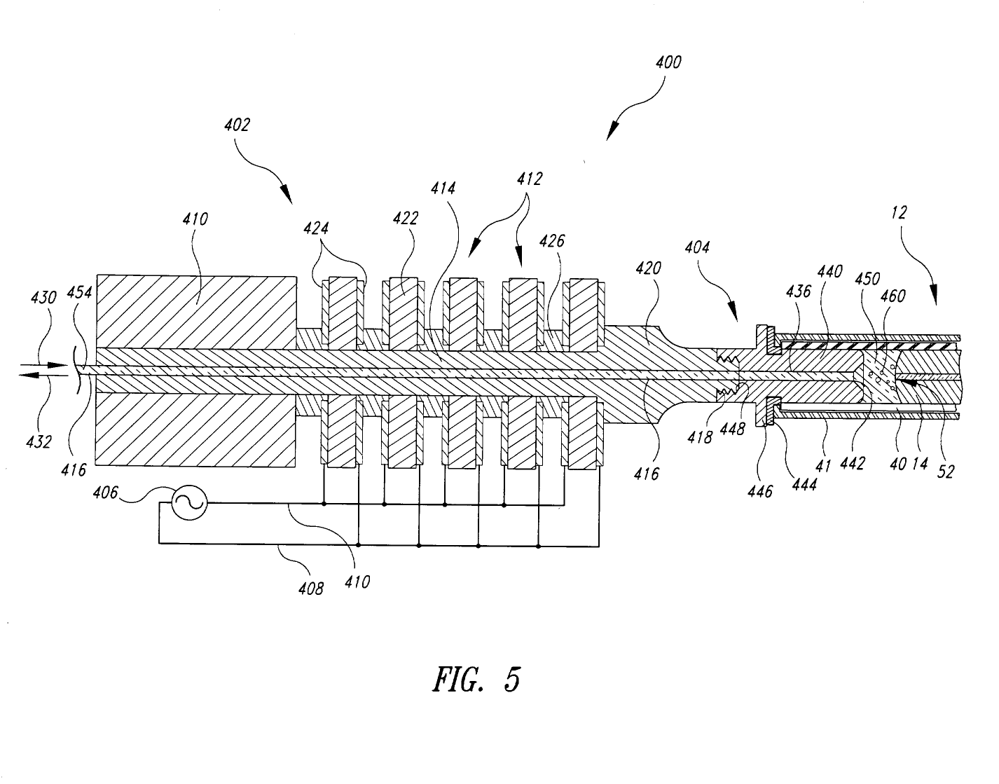

In a fifth embodiment, depicted in FIG. 5, of the present invention, an ultrasound field interactive cleaning apparatus 400 comprises an ultrasonic power supply 406, electrical leads 408 and 410, an ultrasound impedance transformation assembly 402, and an exchangeable probe tip assembly 404. The ultrasound impedance transformation assembly 404 comprises a mass 410, a plurality of ring assemblies 412, a main body liquid transport tube 416 connected to an ultrasonic cleaning liquid supply which is not shown, and a vibration transference structure 420 terminated by a main body thread interface 418. Each of the ring assemblies 412 comprises a PZT ceramic ring 422 and at least two electrodes 424 positioned so as to excite, by electric pulse, the PZT ceramic ring 422. Positioned between each of the ring assemblies 412 is a ring assembly spacer 426. The exchangeable probe tip assembly 404 comprises a liquid jet/vacuum probe tip 440, a probe tip nozzle 442, a probe tip cushioning seal 444, a probe tip shoulder 446, and a probe thread interface 448.

The exchangeable probe tip assembly 404 is inserted into the optical fiber connector tip 12 so that the probe tip cushioning seal 444 abuts the housing 41 and the liquid jet/vacuum probe tip 440 is held within the sleeve 40. In this manner, the probe tip nozzle 442 is placed near to but not in contact with the optical fiber end surface 52. Also in this manner, the probe tip nozzle 442 is axially aligned with the optical fiber end surface 52.

An ultrasonic cleaning liquid 454 is delivered by one of various means in ultrasonic liquid injection direction 430 from the ultrasonic cleaning liquid supply, which is not shown. The ultrasonic cleaning liquid 454 flows through the main body liquid transport tube 416, through the probe liquid transport tube 436, thence into a liquid-filled gap 450 between the probe tip nozzle 442 and the ferrule 14. Electrical pulses from the ultrasonic power supply 406 transmitted through the electrical leads 408 and 410 to the electrodes 424 attached to each PZT ceramic ring 422 excite the PZT material so as to deform it. The deformation of each PZT ceramic ring 422 on all of the ring assemblies 412 creates an ultrasonic vibration that is thence transmitted into the vibration transference structure 420.

The attenuated curve toward the proximal end of the vibration transference structure tends to enhance the ultrasonic impedance transformation in a direction toward, and conducive to cleaning of, the optical fiber end surface 52. The sectional shapes of the main body liquid transport tube 416 and the probe liquid transport tube 436 are also selectable to enhance said transformation.

Ultrasonic impedance transformation within the vibration transference structure is transferred to the ultrasonic cleaning liquid 454 within the main body liquid transport tube 416 and the probe liquid transport tube 436. Transformation is then directed by the probe tip nozzle 442 to create a cavitation effect 460 in the ultrasonic cleaning liquid 454 within the liquid-filled gap 450. The cavitation effect 460 thence enhances the cleaning effect of the ultrasonic cleaning liquid 454 so as to agitate chemicals and particles on the surface of the ferrule 14 and the optical fiber end surface 52. The probe tip cushioning seal 444 acts to limit undesired vibration against the housing 41 and sheath 40.

After an optimal cleaning time, the ultrasonic cleaning liquid 454 is withdrawn by negative pressure in ultrasonic liquid removal direction 432.

We claim the following methods and apparatuses for cleaning an optical fiber connector tip:

1. A method and apparatus for cleaning by means of a directed stream of droplets of a cleaning liquid, which comprises:
a liquid reservoir for holding the cleaning liquid;
a liquid jet probe body for directing the cleaning liquid toward the optical fiber connector tip;
means for propelling the cleaning liquid; and
means for actively removing the cleaning liquid.

2. The apparatus of claim 1, wherein the cleaning liquid propelling means includes a liquid droplets generator by which means the cleaning liquid is propellable at high speed toward the optical fiber end surface.

3. The apparatus of claim 2, wherein the liquid droplets generator means includes piezo material and a source of power to said piezo material.

4. The apparatus of claim 1, wherein the cleaning liquid evacuation means includes a vacuum system.

5. A method and apparatus for cleaning by means of an oversize cleaning ferrule, which comprises:
an oversize cleaning ferrule; and
a vacuum source or a pressure source.

6. A method and apparatus for cleaning by means of plasma discharge, which comprises:
a sleeve interface body;
a gas injection passage;
a gas removal passage;
an O-ring seal;
a pressure containment chamber;
a plurality of electrodes; and
a power source.

7. The apparatus of claim 6, wherein the pressure containment chamber means is a vacuum/pressure system capable of maintaining pressure between 10 and 0.001 torr.

8. The apparatus of claim 6, wherein oxidized residue of the plasma cleaning process, if any, is removable by introduction of a pressurized gas through the gas injection nozzle and removal of said gas and said oxidized residue through the gas removal nozzle.

9. The apparatus of claim 6, wherein the gas injection passage means is used to introduce a mixture of oxidizing gas and ions.

10. A method and apparatus for cleaning by means of a steam cleaning system which comprises:
a liquid transfer tube;
a heater element;
a jet of steam of cleaning liquid
means for introducing said cleaning liquid into the apparatus;
a power supply.

11. The apparatus of claim 10, wherein the cleaning liquid introducing means provides the cleaning liquid in a controlled, or metered, manner to the optical fiber end surface to be cleaned, such that heating of the liquid of an optimal cleaning nature occurs.

12. The apparatus of claim 10, wherein the steam cleaning liquid means is pure water.

13. The apparatus of claim 10, wherein the steam cleaning liquid means is a solution of pure water and alcohol.

14. The apparatus of claim 10, wherein the steam cleaning liquid means is a solution of pure water and other additive.

15. A method and apparatus for cleaning by means of ultrasound field interactive, which comprises:
an ultrasonic cleaning liquid;
means for introducing said ultrasonic cleaning liquid into the apparatus;
a mass;
a plurality of ring assemblies, each comprising a PZT ceramic ring and at least two electrodes;
an ultrasonic power supply;
an impedance transformation means, and
a liquid jet/vacuum probe tip which is capable of non-contact interface with a optical fiber connector tip.

16. The apparatus of claim 15, wherein the ring assemblies are capable of generating a cavitation effect within the liquid-filled gap to affect the optical fiber end surface.

17. The apparatus of claim 15, wherein the frequencies employed are within the range of 47 Hz to 5 MHz, inclusive.

18. The apparatus of claim 15, wherein the ultrasonic cleaning liquid is channeled to and from the liquid jet/vacuum probe tip by means of the same channel.

19. The apparatus of claim 15, wherein the ultrasonic cleaning liquid is channeled to and from the liquid jet/vacuum probe tip by means of a different channel.

20. The apparatus of claim 15, wherein a probe tip cushioning seal absorbs undesired vibration against the housing and sheath of the optical fiber connector tip.

21. The apparatus of claim 15, wherein the liquid jet/vacuum probe tip is interchangeable to adapt the apparatus for use with various optical fiber connector types.

22. The apparatus of claim 15, wherein piezomagnetic vibration is used to generate the ultrasonic or sonic cleaning effect.

23. The apparatus of claim 15, wherein electromagnetic vibration is used to generate the ultrasonic or sonic cleaning effect.

24. The apparatus of claim 15, wherein magnetoelastic vibration is used to generate the ultrasonic or sonic cleaning effect.

25. The apparatus of claim 15, wherein magnetomechanical vibration is used to generate the ultrasonic or sonic cleaning effect.
